(19) United States
(12) Patent Application Publication
(10) Pub. No.: US 2010/0236129 A1
(43) Pub. Date: Sep. 23, 2010

(54) Simulated crawdad eggs, or simulated crawdad babies

(76) Inventor: Jan Jay Rigney, Owasso, OK (US)

Correspondence Address: Jan Jay Rigney, 11880 E. 86th St. N., Owasso, OK, 74055, US

(21) Appl. No.: 12/405,244

(22) Filed: Mar. 17, 2009

(51) Int. Cl. A01K 85/00

(52) U.S. Cl. 43/42.26; 43/42.39; 43/42.24; 43/42.47

(57) ABSTRACT

An artificial bait for fishing, or a component to be added to an artificial bait or hook for fishing, that includes, or simulates, crawdad eggs, and/or crawdad babies, or simulates a crawdad with crawdad eggs, and/or crawdad babies attached to it.

### FIELD OF INVENTION

This invention applies to, and relates to, artificial bait(s) or lure(s) for fishing, and crawdad or crayfish type fishing lures and jigs, and more specifically, the unhatched eggs of crawdads or crayfish, and/or newly hatched babies of crawdads or crayfish.

### BACKGROUND OF THE INVENTION

When a female crawdad or crayfish has reproduced with a male crawdad or crayfish, it carries the eggs under its' tail, on, or attached to its' body until they have hatched. Additionally, for a period time after they have hatched, she continues to carry the babies in a group under her tail, on, or attached, to her body. This group of newly hatched baby crawdads can number into the thirties or more. They remain with the mother on her body, typically under her tail, until they have grown large enough to adequately have a chance for survival on their own. While there are numerous different types of artificial fishing lures and baits which simulate the appearance of a crawdad or crayfish, and, there are numerous artificial fishing lures and baits that simulate fish eggs or salamander eggs, there are no artificial lures or baits that incorporate the embodiment of crawdad or crayfish eggs attached to the body or underside of a crawdad. And, there are no artificial lures or baits that incorporate the embodiment of crawdad or crayfish babies attached to the body or residing on, or in a group under the tail, or attached to the body of a crawdad or crayfish, after they have hatched, before they are mature enough to leave the safety of the mother crawdad and fend for themselves.

### OBJECTS AND ADVANTAGES

Among the objects and advantages of this invention are the following:

To provide a fishing lure that simulates a crawdad carrying unhatched eggs.

To provide a fishing lure that simulates a crawdad carrying baby crawdads.

To provide a fishing lure that simulates a crawdad body carrying unhatched eggs, that is added to a hook for fishing.

To provide a fishing lure that simulates a crawdad body carrying hatched baby crawdads, that is added to a hook for fishing

To provide a separate component for an artificial fishing lure that can be added to a fishing lure that simulates the appearance of a crawdad or crayfish carrying unhatched eggs under its' tail.

To provide a separate component for an artificial fishing lure that can be added to a fishing lure that simulates the appearance of a crawdad or crayfish carrying baby crawdads or crayfish under its' tail.

To provide a separate component for an artificial fishing lure that simulates the appearance of eggs under the tail of a crawdad which provides additional weight to increase the fall of the lure in the water, or aids in the casting of the lure by the addition of this weight.

To provide a separate component for an artificial fishing lure that simulates the appearance of baby crawdads under the tail of a crawdad which provides additional weight to increase the fall of the lure in the water, or aids in the casting of the error lure by the addition of this weight.

To provide a separate component for an artificial fishing lure that simulates the appearance of eggs under the tail of a crawdad which provides extra bulk and drag, and thereby, helps to decrease the fall rate of the lure in the water.

To provide a separate component for an artificial fishing lure that simulates the appearance of baby crawdads under the tail of a crawdad which provides extra bulk and drag, and thereby, helps to decrease the fall of the lure in the water.

To provide a separate component for an artificial fishing lure that simulates the appearance of eggs under the tail of a crawdad which provides a method of dispensing scent into the water to attract fish.

To provide a separate component for an artificial fishing lure that simulates the appearance of baby crawdads under the tail of a crawdad which provides a method of dispensing scent into the water to attract fish.

To provide a portion of a crawdad or crayfish fishing lure which simulates eggs attached to the body or underside of a crawdad or crayfish whereby providing more enticement of the fish to attack the lure.

To provide a portion of a crawdad or crayfish fishing lure which simulates baby crawdads attached to or under the tail of a crawdad or crayfish, whereby providing more enticement of the fish to attack the lure because of opportunity to not only eat the crawdad but also the helpless crawdad babies.

To provide an artificial fishing lure that simulates a crawdad or crayfish carrying eggs on it's body or under its' tail, which further entices a fish to strike because the ability of the mother crawdad to escape is impaired by the eggs on its' body or under its' tail.

To provide a portion or separate component of an artificial fishing lure that simulates a crawdad or crayfish, carrying eggs on it's body or under its' tail, which further entices a fish to strike because the ability of the mother crawdad to escape is impaired by the presence of baby crawdads on its' body or under its' tail.

### SUMMARY OF THE INVENTION

In accordance with the foregoing objects, the invention contemplates an artificial bait formed of any number of materials including but not limited to elastomeric materials, polymers, wood, foam, sponge, metal, plastic, or other suitable material, fashioned to simulate the appearance of crawdad eggs or crawdad babies attached to the body of a crawdad or a combination of ac crawdad carrying eggs and/or babies. Or, crawdad eggs and/or crawdad babies, to be added to an existing body to simulate the appearance of crawdad eggs or crawdad babies attached to the body, or underside of the tail of a crawdad. The design may be gross or of fine detail. It may incorporate eggs or baby crawdads or a combination of the two. The babies could be very recently hatched, or relatively mature. The eggs and/or babies may be buoyant, or may be bulky to create drag in order to slow the fall, or may be dense to aid in adding weight, or may be porous to dispense scent. The design may include both the body and eggs and/or babies. Or, the design may incorporate only the eggs, only the babies, or a combination of both babies and eggs which are separate but added to an existing crawdad lure to simulate a crawdad with eggs and/or babies.

While the above description contains many specificities, the reader should not construe these as limitations on the scope of the invention, but merely as examples of different embodiments thereof. Those skilled in the art may envision many other possible variations that are with in its' scope. Accordingly, the scope of the invention is to be determined by the appended at claims and their legal equivalents, and not by the examples that have been given.

### SUMMARY AND DESCRIPTIONS OF THE DRAWINGS

FIG. 1 illustrates a lure, consisting of a crawdad like body (1), attached to the body is a hook (2), with a means of attachment (3), to a string (4). A portion of the crawdad body contains eggs and/or baby crawdads (5) or other object similar in appearance to crawdad eggs and/or crawdad babies. In this emodiment, the eggs and/or babies are under the crawdad tail (6).

FIG. 2 illustrates a similar lure as FIG. 1, but with the addition of a “bill” (7), or “planeing surface” which causes the lure to dive on retrieve. In this embodiment, the string (4) is attached to the bill by a ring (3), and the hook (2) is attached to the underside of the lure body (1). The eggs and/or crawdad babies (5) are under the tail (6).

FIG. 3 illustrates a similar lure as illustrated in either “FIG. 2”. In this embodiment the “bill” or “planning surface” (7) is on the back of the lure rather than the front of the lure. The body (1), hook (2), means of attachment (3), string (4), crawdad/eggs and/or babies (5), are under the tail (6).

FIG. 4 illustrates a lure consisting of a hook (2). The hook may or may not a incorporate a lead, metal or similarly weighted head, permanently, or not permanently, attached the hook (2), and eye of the hook (3). In this embodiment, the body (1), is attached by running the hook through the crawdad body (1), until the point of the hook (2), is exposed. In this embodiment, the crawdad eggs and/or babies (5) or other object similar in appearance to crawdad eggs and/or crawdad babies, is added as a separate component.

FIG. 5 illustrates a lure consisting of a hook (2). The hook may or may not a incorporate a lead, metal or similarly weighted head permanently, or not permanently, attached the hook (2), and eye of the hook (3). In this illustration, the body (1), is attached by running the hook through the crawdad body (1), until the point of the hook (2), is exposed. In this example, the crawdad eggs and/or babies (5) or other object similar in appearance to crawdad eggs and/or crawdad babies is added as a separate component to the string (4), which is attached to the hook (2) at the eye (3).

FIG. 6 illustrates a similar lure as illustrated in “FIG. 5”, however, in this example the body (1) is composed of metal weight permanently attached to the hook (2), A skirt (8) is attached to the hook and weight. The string (4) is attached at the eye (3). A weedguard (9) is embedded into the weight/body (1). The crawdad eggs and/or babies (5) or other object similar in appearance to crawdad eggs and/or crawdad babies, is added as a separate component (5), in this example, by being slideably engaged on the hook (2).

FIG. 7 illustrates a separate crawdad body (1) and separate hook (2). In this illustration, the body (1), is attached by running the hook through the crawdad body (1), until the point of the hook (2), is exposed, then the hook is turned and the point is then brought into the body again with the point being almost exposed through the body. The string (4) is attached to the string at the eye (3) of the hook (2). In this example the hook does not incorporate a lead or weight, however, the hook may or may not a incorporate a lead, metal or similarly weighted head, and the head, if used, may be either permanently, or not permanently attached to the hook (2). The body (1) incorporates eggs, and/or crawdad babies (5), or other object similar in appearance to crawdad eggs and/or crawdad babies.

FIG. 8 illustrates a separate hook (2), a separate skirt (8), and a separate weight (1). In this example these are used to simulate a crawdad body. The weight (1) incorporates a hollow shaft through the center of the weight so that the weight (1) is threaded onto the string (4) and the string (4) is threaded through the weight (1). The string (4) is attached to the hook (2) at the eye (3). In this illustration, the crawdad eggs and/or babies (5) are added as a separate component to the hook (2) by being slideably engaged.

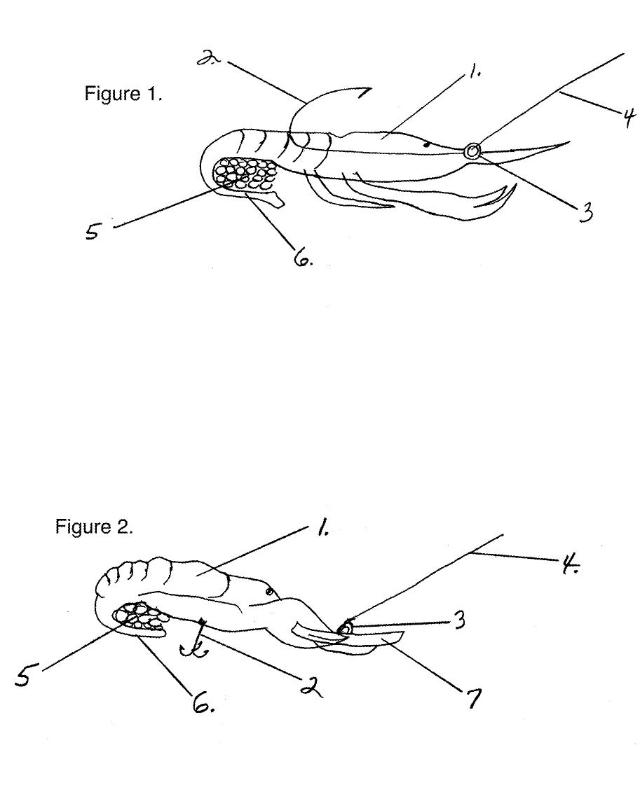

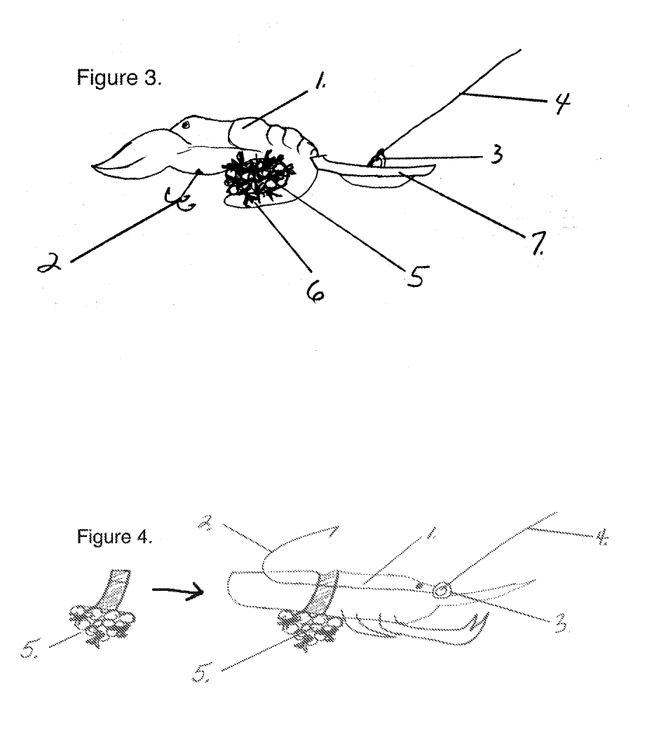

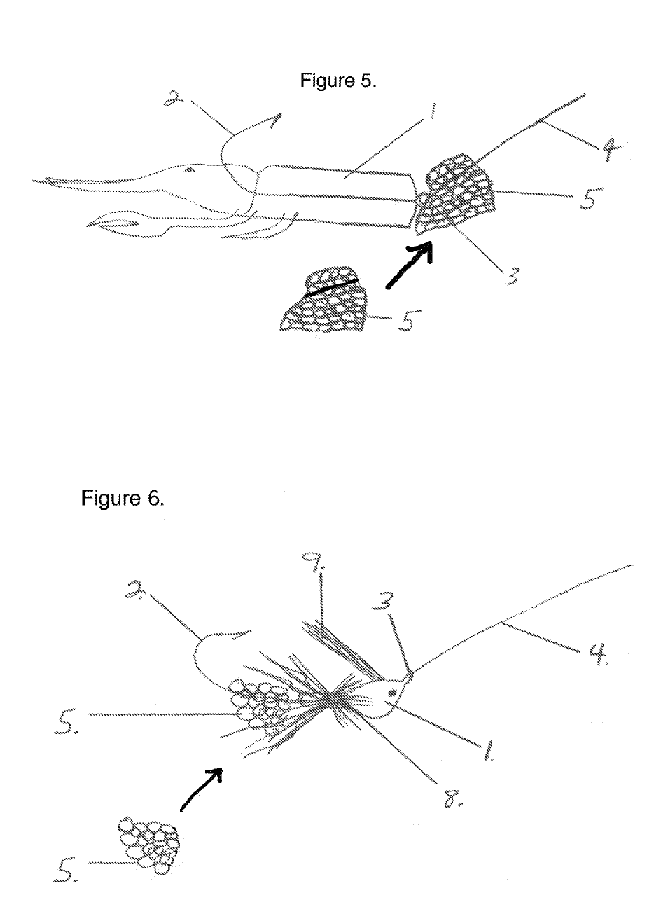

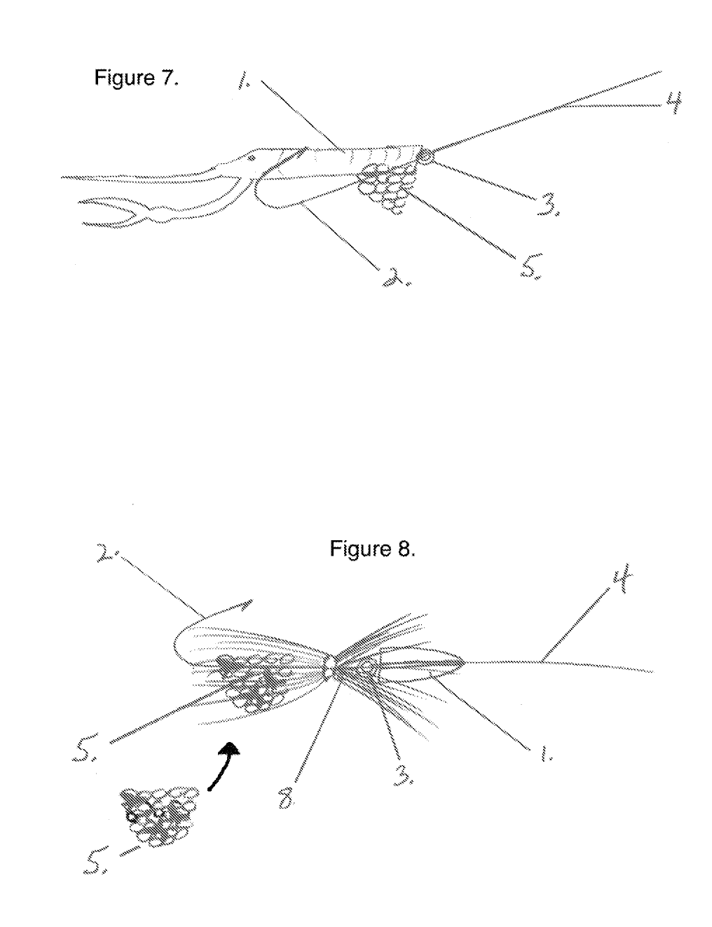

1. An artificial fishing lure that simulates crawdad eggs and/or baby crawdads attached.

2. An artificial fishing lure that simulates a crawdad and crawdad eggs and/or baby crawdads attached.

3. A component, to be added to, an existing artificial fishing lure, that when added simulates crawdad eggs and/or crawdad babies attached.
